(19) United States
(12) Patent Application Publication
(10) Pub. No.: US 2003/0218682 A1
(43) Pub. Date: Nov. 27, 2003

(54) Device and method for displaying a thumbnail picture in a mobile communication terminal with a camera

(76) Inventors: Chae-Whan Lim, Taekgukwangyok-shi (KR); Sang Hyun Lee, Kumi-shi (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/419,984

(22) Filed: Apr. 22, 2003

(30) Foreign Application Priority Data
Apr. 22, 2002 (KR) 2002-22844

(51) Int. Cl. H04N 5/222

(52) U.S. Cl. 348/333.11

(57) ABSTRACT

A device and method for displaying an image in a mobile communication terminal. A camera captures an object's image and generates image data. A display data processor processes the image data generated by the camera on the basis of a display standard. An image codec compresses the image data processed by the display data processor and generates image data of at least one still picture in a still-picture capture mode. A thumbnail generator generates image data of at least one thumbnail picture of a set size from the image data processed by the display data processor in the still-picture capture mode. A user data generator generates user data according to a display mode. A display unit displays the image data on a first display area and displaying the user data on a second display area. A controller cuts off a path of the image data by controlling the display data processor in the still-picture capture mode, drives the image codec and the thumbnail generator such that the image data displayed on the first display area can be compressed, stores the image data compressed by the image codec as the still picture, and stores the image data generated by the thumbnail generator as the thumbnail picture.

### PRIORITY

This application claims priority under 35 U.S.C. §119 to an application entitled “DEVICE AND METHOD FOR DISPLAYING THUMBNAIL PICTURE IN MOBILE COMMUNICATION TERMINAL WITH CAMERA”, filed in the Korean Industrial Property Office on Apr. 22, 2002 and assigned Serial No. 2002-22844, the contents of which are incorporated herein by reference.

### BACKGROUND OF THE INVENTION

1. Field of the Invention

The present invention relates to a device and method for processing data in a mobile communication terminal, and more particularly to a device and method for displaying image data in a mobile communication terminal.

2. Description of the Related Art

Mobile communication terminals have recently developed into structures capable of transmitting high-speed data while retaining their voice communication function. A mobile communication network based on an international mobile telecommunication-2000 (IMT-2000) standard can implement high-speed data communication as well as voice communication using the mobile communication terminal. Data capable of being processed in the mobile communication terminal for performing the data communication can be packet data and image data.

Conventionally, an image processing device includes a camera for capturing an image and a display unit for displaying the image captured by the camera. The camera can use a charge coupled device (CCD) image sensor or a complementary metal oxide semiconductor (CMOS) image sensor. As camera devices become smaller, the image capturing devices must also be miniaturized. A trend has developed wherein mobile communication terminals are equipped with camera devices. Mobile communication terminal can capture images, and display moving and still pictures. Subsequent to capturing an image, the mobile communication terminal can transmit the captured images to a base station.

The image data is displayed on a display unit in units of frames, and also stored in a memory in units of frames. A user can identify the stored image data based on image data displayed in a frame. Thus, if the image data stored in the memory are configured as thumbnail pictures and a plurality of thumbnail pictures are displayed, the user can conveniently identify the image data.

### SUMMARY OF THE INVENTION

Therefore, it is one object of the present invention to provide a device and method capable of generating image data of a thumbnail picture in a mobile communication terminal equipped with a camera.

It is another object of the present invention to provide a device and method capable of generating and storing image data of a corresponding thumbnail picture along with a still picture when a still-picture capture function is performed.

It is yet another object of the present invention to provide a device and method capable of receiving image data and generating and storing a thumbnail picture from the received image data in a mobile communication terminal.

It is still yet another object of the present invention to provide a device and method capable of generating thumbnail pictures from image data stored in a memory provided in a mobile communication terminal, storing the generated thumbnail pictures, and simultaneously displaying at least two thumbnail pictures according to a user's selection.

In accordance with one aspect of the present invention, the above and other objects can be substantially accomplished by of a device for displaying an image in a mobile communication terminal. The device comprises a camera for capturing an object's image and generating image data; a display data processor for processing the image data generated by the camera on the basis of a display standard; an image codec for compressing the image data processed by the display data processor and generating image data of at least one still picture in a still-picture capture mode; a thumbnail generator for generating image data of at least one thumbnail picture of a set size from the image data processed by the display data processor in the still-picture capture mode; a user data generator for generating user data according to a display mode; a display unit for displaying the image data on a first display area and displaying the user data on a second display area; and a controller for cutting off a path of the image data by controlling the display data processor in the still-picture capture mode, driving the image codec and the thumbnail generator such that the image data displayed on the first display area can be compressed, storing the image data compressed by the image codec as the still picture, and storing the image data generated by the thumbnail generator as the thumbnail picture.

Another aspect of the present invention, provides a method for displaying an image in a mobile communication terminal. The mobile communication terminal includes a camera for capturing an object's image and generating image data, a user data generator for generating user data according to a display mode, and a display unit for displaying the image data on a first display area and displaying the user data on a second display area. The method comprises the steps of transmitting the image data generated by the camera and the user data generated by the user data generator to the first and second display areas of the display unit in an image capture mode, and displaying a moving picture; and when a still-picture capture command is generated in the image capture mode, compressing and encoding the image data displayed on the first display area of the display unit, generating image data of at least one still picture and image data of at least one thumbnail picture of a set size, and storing the generated image data.

Yet another aspect of the present invention, provides a method for displaying an image in a mobile communication terminal, The mobile communication terminal includes a user data generator for generating user data according to a display mode, and a display unit for displaying received image data on a first display area and displaying the user data on a second display area. The method comprises the steps of transmitting the received image data and the user data generated by the user data generator to the first and second display areas of the display unit in a communication mode, and displaying a moving picture; and when a still-picture capture command is generated at a time of displaying the received image data, compressing and encoding the image data displayed on the first display area of the display unit, generating image data of at least one still picture and image data of at least one thumbnail picture of a set size, and storing the generated image data.

Still yet another aspect of the present invention, provides a method for displaying an image in a mobile communication terminal, The mobile communication terminal includes an image memory for storing image data of still pictures and image data of thumbnail pictures corresponding to the still pictures, a user data generator for generating user data according to a display mode, and a display unit for displaying the image data on a first display area and displaying the user data on a second display area. The method comprises the steps of displaying a predetermined number of thumbnail pictures stored in the image memory on the first display area in a thumbnail display mode; when a first shift key is input in the thumbnail display mode, shifting a selection bar to a selected thumbnail picture; when a second shift key is input in the thumbnail display mode, displaying the predetermined number of next thumbnail pictures stored in the image memory on the first display area; and when a selection key is input in the thumbnail display mode, reading image data of a still picture corresponding to a selected thumbnail picture and displaying the image data of the still picture corresponding to the selected thumbnail picture on the first display area.

A further aspect of the present invention, provides a method for displaying an image in a mobile communication terminal, The mobile communication terminal includes a camera for capturing an object's image and generating image data, a user data generator for generating user data according to a display mode, and a display unit for displaying the image data on a first display area and displaying the user data on a second display area. The method comprises the steps of transmitting the image data generated by the camera and the user data generated by the user data generator to the first and second display areas of the display unit in an image capture mode, and displaying a moving picture; when a still-picture capture command is generated in the image capture mode, compressing and encoding the image data displayed on the first display area of the display unit, generating image data of at least one still picture and image data of at least one thumbnail picture of a set size, and storing the generated image data; and displaying the predetermined number of thumbnail pictures stored in the image memory on the first display area in a thumbnail display mode, reading image data of a still picture corresponding to a selected thumbnail picture when a selection key is input in the thumbnail display mode, and displaying the image data of the still picture corresponding to the selected thumbnail picture on the first display area.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram illustrating an example of components of a mobile communication terminal in accordance with an embodiment of the present invention;

FIG. 2 is a block diagram illustrating an example of components of a signal processor shown in FIG. 1 in accordance with an embodiment of the present invention;

FIGS. 3A and 3B are block diagrams illustrating an example of components of the image processor shown in FIG. 1 in accordance with an embodiment of the present invention;

FIG. 4 is a block diagram illustrating an example of components of the image processor shown in FIG. 3A in accordance with an embodiment of the present invention;

FIG. 5 is a diagram illustrating an example of a displayed scaled picture and a cropped picture in accordance with an embodiment of the present invention;

FIG. 6 is a diagram illustrating an example of a displayed thumbnail picture in accordance with an embodiment of the present invention;

FIG. 7 is a diagram illustrating another example of a displayed thumbnail picture in accordance with an embodiment of the present invention;

FIG. 8 is a flow chart illustrating an example of steps for generating the thumbnail picture in accordance with an embodiment of the present invention;

FIG. 9 is a flow chart illustrating another example of steps for generating the thumbnail picture in accordance with an embodiment of the present invention;

FIG. 10 is a flow chart illustrating an example of steps for displaying a generated thumbnail picture and selecting a main picture corresponding to the generated thumbnail picture in accordance with an embodiment of the present invention;

FIGS. 11A and 11B are diagrams illustrating an example of displayed thumbnail pictures in accordance with embodiments of the present invention;

FIG. 12 is a block diagram illustrating another example of components of the image processor shown in FIG. 1 in accordance with an embodiment of the present invention;

FIG. 13 is a flow chart illustrating an example of steps for generating at least one thumbnail picture in the mobile communication terminal with the image processor shown in FIG. 12 in accordance with an embodiment of the present invention; and

FIG. 14 is a flow chart illustrating another example of steps for generating the thumbnail picture in the mobile communication terminal with the image processor shown in FIG. 12 in accordance with an embodiment of the present invention.

### DETAILED DESCRIPTION OF THE PREFERRED EMBODIMENTS

Embodiments of the present invention will be described in detail with reference to the accompanying drawings. In the drawings, the same or similar elements are denoted by the same reference numerals.

Those skilled in the art will appreciate that specific criteria such as a transmission rate of an image signal transmitted from a camera, the number of pixels of image signals captured by the camera, a size of a thumbnail picture, and so on are described only for illustrative purposes to help in understanding the present invention. It should also be appreciated that the present invention can be implemented without the specific criteria.

The term “image capture mode” refers to an operating mode for capturing image signals through a camera and displaying data of the image signals on a display unit. The term “thumbnail picture” refers to image data generated by reducing a number of pixels of frame image data. The term “shift key” refers to a key for selecting and shifting at least one thumbnail picture while in a thumbnail display mode. The term “preview” refers to an operation of displaying image data of moving picture signals captured by the camera. The term “still-picture capture mode” refers to an operating mode of capturing a still picture while in a preview state and generating a thumbnail picture from the captured still picture.

It is assumed that a device for capturing and displaying an image is a mobile communication terminal in accordance with embodiments of the present invention. However, the device and method in accordance with the embodiments of the present invention can be applied to any mobile communication device for displaying an image using a camera.

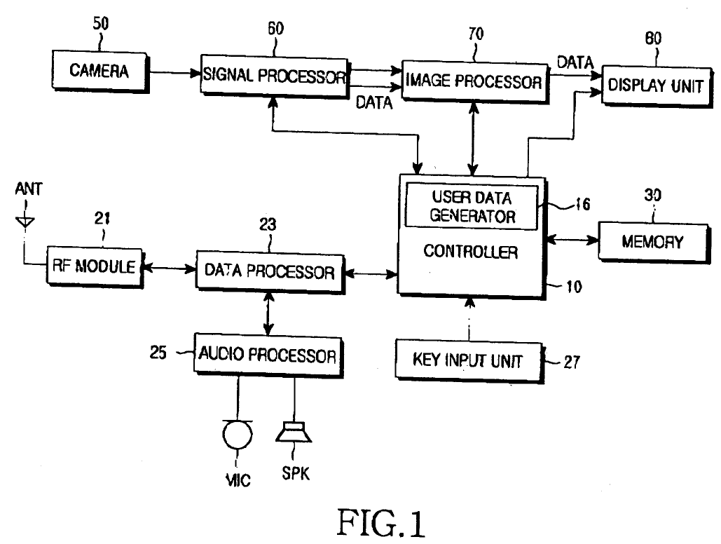

FIG. 1 is a block diagram illustrating an example of components of be a mobile communication terminal in accordance with an embodiment of the present invention.

Referring to FIG. 1, a radio frequency (RF) module 21 performs communication functions for the mobile communication terminal. The RF module 21 includes an RF transmitter (not shown) for up-converting and amplifying a frequency of a signal to be transmitted, an RF receiver (not shown) for performing a low noise amplification for a received signal and down-converting a frequency of the amplified received signal, and so on. The RF module transmits and receives signals via antenna (ANT). A data processor 23 includes a transmitter (not shown) for encoding and modulating the transmission signal, a receiver (not shown) for demodulating and decoding the received signal, and so on. The data processor 23 can be configured by a modem and a coder/decoder (codec). An audio processor 25 reproduces an audio signal received from the data processor 23 and outputs it via speaker (SPK). The audio processor 25 also transmits an audio signal from a microphone (MIC) to the data processor 23.

A key input unit 27 includes keys for inputting numeric and character information and function keys for setting various functions. In embodiment of the present invention, the key input unit 27 can include an image capture key for performing a preview mode, a still-picture capture key for storing image data displayed in the preview mode as a still picture, and a thumbnail picture storage key for generating at least one thumbnail picture from the displayed image data and storing the generated thumbnail picture.

A memory 30 comprises a program memory, a data memory and an image memory for storing still-picture image data. The program memory can store programs for controlling a general operation of the mobile communication terminal, programs for generating and storing image data of a thumbnail picture image data along with image data of a main picture, picture information, and so on, and programs for displaying and selecting the stored thumbnail picture. The data memory performs a function of temporarily storing data generated while the programs are being performed. Moreover, the image memory can store still-picture image data and items of the thumbnail picture image data corresponding to the still-picture image data.

The controller 10 controls the operation of the mobile communication terminal. Optionally, the controller 10 can include the data processor 23. In accordance with an embodiment of the present invention, in response to a key input from the key input unit 27, the controller 10 sets an image capture mode by controlling the signal processor 60 and performs a control operation such that image data captured according to the set image capture mode can be displayed. Further, the controller 10 can store the programs for generating and storing thumbnail picture image data along with main picture image data, picture information, and so on, and the programs for displaying and selecting the stored thumbnail picture image data. Furthermore, the controller 10 controls the data memory for temporarily storing data generated while the programs are being performed.

A camera 50 for capturing an image includes a camera sensor (not shown) for converting an optical signal of the captured image into an electric signal. In an embodiment of the invention, the camera sensor is a charge coupled device (CCD) image sensor. A signal processor 60 converts the image signal output from the camera 50 into digital image data. In an embodiment of the invention, the signal processor 60 can be implemented by a digital signal processor (DSP). The signal processor 60 can be embedded in the camera 50. In an embodiment of the invention, signal processor 60 is separate from the camera 50.

An image processor 70 generates screen data from the image data output by the signal processor 60. The controller 10 controls the image processor 70 to transmit received image data on the basis of a standard of the display unit 80. Moreover, the image processor 70 compresses and decompresses the image data.

The display unit 80 displays the image data received from the image processor 70 on a screen, and displays user data received from the controller 10. In an embodiment of the invention, the display unit 80 can be a liquid crystal display (LCD). In other embodiments of the invention, the display unit 80 can include an LCD controller, a memory for storing image data, LCD elements, and so on. When the LCD is implemented in the form of a touch screen, the key input unit 27 and the LCD can comprise an input unit.

An operation of the mobile communication terminal will now be described with reference to FIG. 1. If a user performs a dialing operation through the key input unit 27 when transmitting a call signal, and sets a call signal transmitting mode, the controller 10 detects the set call signal transmitting mode, processes dialing information received from the data processor 23, converts the dialing information into an RF signal through the RF module 21, and outputs the RF signal via the antenna ANT. If a called party generates a response signal, the controller 10 detects the response signal through the RF module 21 and the data processor 23. A voice communication path is established through the audio processor 25, such that the user can communicate with the called party.

In a call signal receiving mode, the controller 10 detects the call signal receiving mode through the data processor 23, and generates a ring signal through the audio processor 25. If the user provides a response to the ring signal, the controller 10 detects the response. Thus, the voice communication path is established through the audio processor 25, such that the user can communicate with a calling party. The voice communication in the call signal transmitting and receiving modes has been described as an example. It should be appreciated by those skilled in the art that the mobile communication terminal can perform a data communication function for packet data and image data communications as well as voice communication functions. Moreover, when the mobile communication terminal is in a standby mode or performs character communication, the controller 10 controls the display unit 80 such that the display unit 80 displays character data processed by the data processor 23.

The mobile communication terminal captures an image of a person or peripheral environment, and displays or transmits the image. The camera 50 is mounted in the mobile communication terminal or connected to the mobile communication terminal at a predetermined external position. That is, the camera 50 can be an internal or external camera. In embodiments of the invention the camera 50 can use a charge coupled device (CCD) image sensor or a complementary metal oxide semiconductor (CMOS) image sensor. After an image signal captured by the camera 50 is converted into an electric signal, the electric signal is applied to the signal processor 60. The signal processor 60 then converts an analog image signal into digital image data and then outputs the digital image data to the image processor 70.

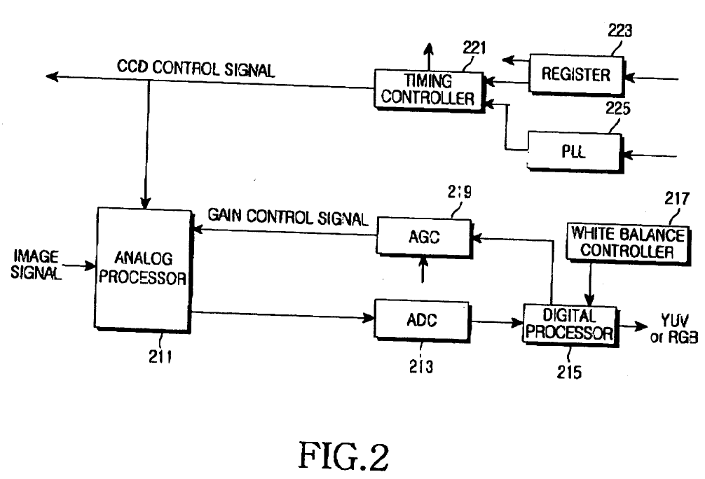

FIG. 2 is a block diagram illustrating an example of components of a the signal processor 60 shown in FIG. 1 in accordance with an embodiment of the present invention.

Referring to FIG. 2, an analog processor 211 receives an analog image signal received from the sensor of the camera 50, and controls the amplification of the image signal in response to a gain control signal. An analog-to-digital converter (ADC) 213 converts the analog image signal received from the analog processor 211 into digital image data and then outputs the digital image data. In an embodiment of the invention, the ADC 213 can be an 8-bit ADC. A digital processor 215 receives an output from the ADC 213, converts the digital image data into YUV or RGB data and outputs the YUV or RGB data. The digital processor 215 includes an internal line memory or frame memory (not shown), and outputs the processed image data in units of lines or frames. A white balance controller 217 controls a white balance of light. An automatic gain controller (AGC) 219 generates the gain control signal for controlling a gain of the image signal, and outputs the generated gain control signal to the analog processor 211.

A register 223 stores control data received from the controller 10. A phase-locked loop (PLL) circuit 225 generates a reference clock to control an operation of the signal processor 60. A timing controller 221 receives the reference clock from the PLL circuit 225, and generates a timing control signal to control the operation of the signal processor 60.

An operation of the signal processor 60 will now be described. The camera 50 includes a charge coupled device (CCD) image sensor, and converts an optical signal of the captured image into an electric signal to output the electric signal. The analog processor 211 processes the image signal received from the camera 50. The analog processor 211 controls a gain of the image signal in response to a gain control signal. The ADC 213 converts the analog image signal received from the analog processor 211 into digital image data and then outputs the digital image data. The digital processor 215 includes a memory for storing the image data, converts the digital image data into RGB or YUV image data, and outputs the RGB or YUV image data. The memory storing the digital image data can be implemented by a line memory for storing the image data in units of lines or a frame memory for storing the image data in units of frames. It is assumed that the line memory is employed in accordance with an embodiment of the present invention. Moreover, it is assumed that the digital processor 215 converts the digital image data into the YUV image data in accordance with an embodiment of the present invention.

The white balance controller 217 generates a control signal for controlling a white balance of the image signal. The digital processor 215 adjusts a white balance of the processed image data. The AGC 219 generates a signal for controlling a gain of the image signal and applies the gain control signal to the analog processor 211. The register 223 stores a mode control signal received from the controller 10. The PLL circuit 225 generates a reference clock to be used in the signal processor 60. The timing controller 221 generates various control signals for the signal processor 60 in response to the reference clock received from the PLL circuit 225.

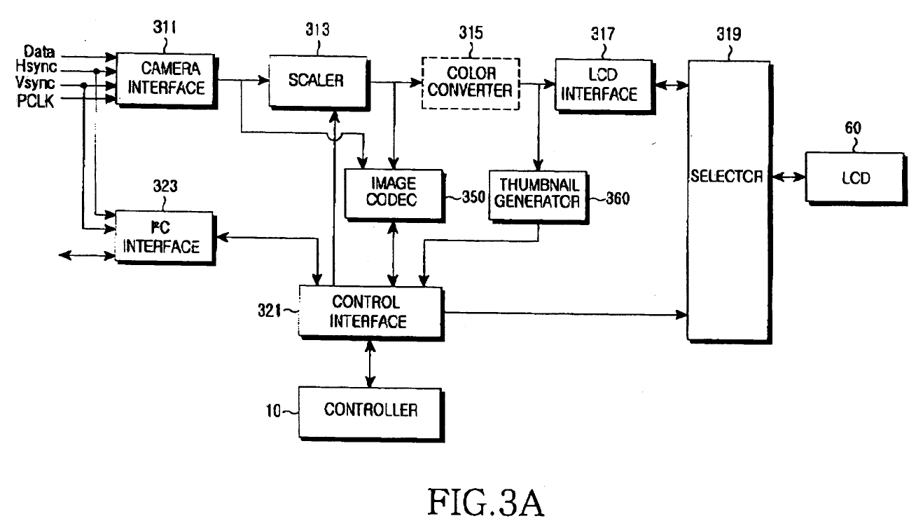

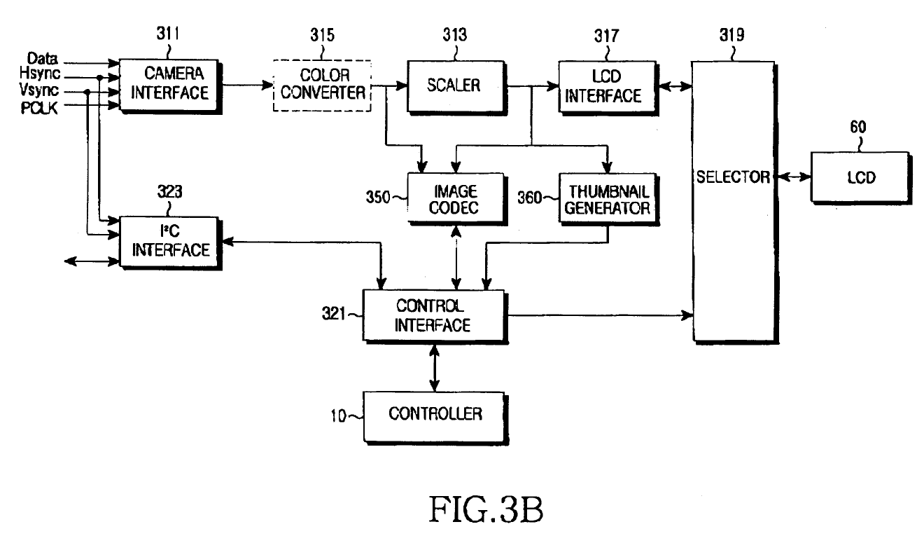

FIGS. 3A and 3B are block diagrams illustrating an example of components of the image processor 70 shown in FIG. 1 in accordance with an embodiment of the present invention. The image processor 70 performs an interface function for image data between the signal processor 60 and the display unit 80. That is, the image processor 70 adjusts data of image signals captured by the camera 50 to a size of the display unit 80, and converts data of the image signals captured by the camera 50 on the basis of a color standard of image data to be displayed on the display unit 80.

Referring to FIG. 3A, a camera interface 311 performs an interface function for image data output from the signal processor 60. It is assumed that the image data output from the signal processor 60 is based on a YUV format, and the display unit 80 displays image data of an RGB format. In an embodiment of the present invention, it is assumed that the image data output from the camera 50 is based on a YUV 422 (16 bits) format and fixed to a common intermediate format (CIF) size of 352×288. Moreover, it is assumed that the display unit 80 based on the RGB format has a size of 128×112.

In response to a control signal output from the controller 10, a scaler 313 scales data of the image signals captured by the camera 50 such that the image data can be displayed on the display unit 80. That is, as described, the number of pixels of the image signals captured by the camera 50 is the CIF size of 352×288, and the number of pixels of image data capable of being displayed is 128×112 or 128×96. Thus, the scaler 313 reduces and crops the pixels of the image signals output from the camera 50 to the number of the pixels of the image data capable of being displayed on the display unit 80. However, if the display unit 80 can display image data having a size larger than the number of the pixels of the image signals output from the camera 50, the scaler 313 can be designed such that the pixels of the image signals output from the camera 50 can be enlarged and displayed under the control of the controller 10. A method for displaying the enlarged image pixels selects the number of pixels capable of being displayed from the image data output from the camera 50, and displays the selected pixels.

A color converter 315 converts YUV data received from the scaler 313 into RGB data, and then outputs the RGB data. When the camera 50 generates the image data in the RGB format or the display unit 80 can display image data of the YUV format, the configuration of the color converter 315 can be omitted.

A liquid crystal display (LCD) interface 317 performs an interface function for image data associated with the display unit 80. The LCD interface 317 includes an internal buffer (not shown), and performs buffering for the image data interfaced with the display unit 80.

Under the control of the controller 10, an image codec 350 compresses data of the captured image signals or recovers the compressed image data. In an embodiment of the present invention, it is assumed that the image codec 350 is a joint photographic experts group (JPEG) codec.

A thumbnail generator 360 generates thumbnail picture image data from the data of the captured image signals and then transmits the generated thumbnail picture image data to the controller 10. If a still-picture capture command is generated, the thumbnail generator 360 receives image data to be registered as a still picture and generates the thumbnail picture image data from the received image data. Moreover, the thumbnail generator 360 can generate the thumbnail picture image data from image data displayed on the display unit 80 in response to the user's selection.

A control interface 321 performs an interface function between the image processor 70 and the controller 10, and between the display unit 80 and the controller 10.

In response to a path control signal output from the controller 10, a selector 319 selects data output from the image processor 70 or data output from the controller 10, and outputs the data to the display unit 80. Here, a first path control signal refers to a signal for activating a bus between the image processor 70 and the display unit 80, and a second path control signal refers to a signal for activating a path between the controller 10 and the display unit 80. The controller 10 allows the display unit 80 to perform two-way communication through the selector 319.

The configuration shown in FIG. 3B is similar to that shown in FIG. 3A and vice versa except for the color converter 315 being connected between the camera 50 and the scaler 313.

An operation of transmitting data of the image signals captured by the camera 50 to the display unit 80 will now be described. The image processor 70 controls a transmission rate of moving picture data of the image signals captured by the camera 50, and stores input image data in a memory of the display unit 80 through the LCD interface 317. The number of pixels of the image signals corresponding to one frame output from the camera 50 is a CIF size of 352×288, and pixels of the image data from the camera are reduced and partially removed (or cropped) on the basis of the number of pixels (128×112 or 128×96) of image data corresponding to one frame capable of being displayed. Thus, the scaler 313 of the image processor 70 partially removes the pixels of the image signals output from the camera 50 or selects a partial area of the pixels such that the display unit 80 can appropriately display the pixels of the image signals from the camera 50 on a zoom screen. The transmission rate of the image data is fixedly designated on the basis of a master clock. A flow of image signals or data between the camera 50, the image processor 70 and the display unit 80 is affected by an access rate for the display unit 80. Thus, the LCD interface 317 includes a buffer such that a rate of the image signals to be read from the camera 50 and a rate of the image data to be written to the display unit 80 can be adjusted, and temporarily buffer the image signals or data in the buffer.

To display a moving picture screen corresponding to the image signals captured by the camera 50 on the display unit 80, the user can capture a still picture from displayed image data and store the captured still picture. That is, the user can store the display image data as the still picture using a still-picture capture key arranged on the key input unit 27. If a still-picture capture command is generated, the controller 10 terminates an operation of transmitting an output of the image processor 70 to the display unit 80, and then reproduces an image displayed on the display unit 80 as the still picture and drives the image codec 350. The image codec 350 receives the image data of one frame corresponding to the displayed image, and encodes the input image data in the JPEG format to output the encoded image data to the control interface 321. Then, the controller 10 stores compressed image data as a still picture in the memory 30. Further, if a still-picture capture function is performed, the controller 10 can generate and store a thumbnail picture of a selected still picture by driving the thumbnail generator 360. Furthermore, if a thumbnail picture key arranged on the key input unit 27 is input, the controller 10 performs a control operation such that the image data displayed on the display unit 80 can be applied to the thumbnail generator 360. The thumbnail generator 360 generates a thumbnail picture and then stores the generated thumbnail picture in the memory 30.

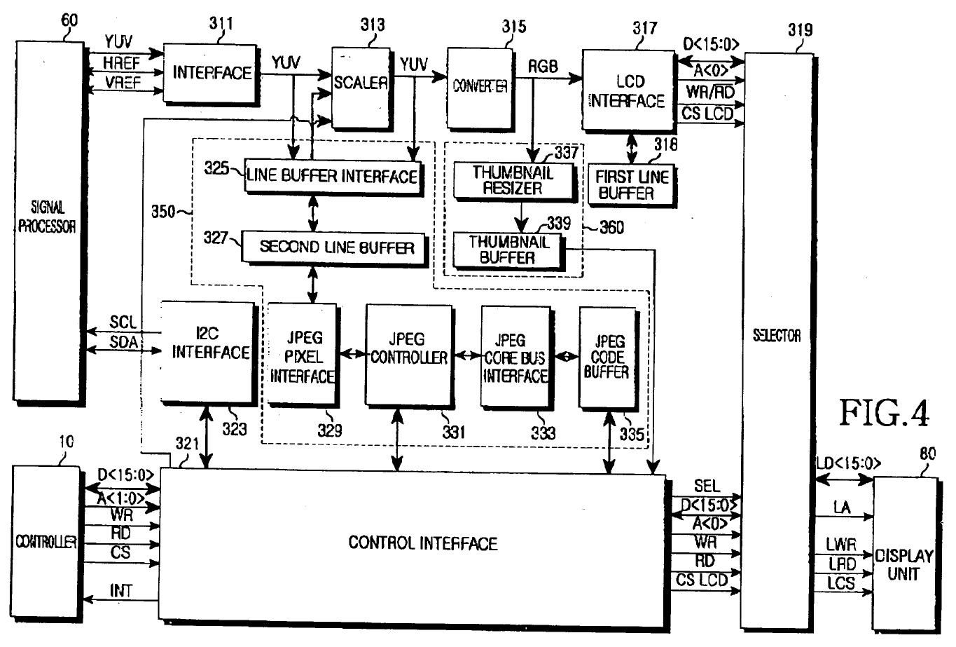

FIG. 4 is a block diagram illustrating an example of components of the image processor 70 shown in FIG. 3A in accordance with an embodiment of the present invention.

Referring to FIG. 4, the image processor 70 performs an interface function for image data between the signal processor 60 and the display unit 80, and compresses and decompresses data of image signals received from the camera 50 in a joint photographic experts group (JPEG) format. The image processor 70 generates a thumbnail picture by cropping pixels and lines of the compressed image data.

Referring to FIG. 4, the image processor 70 has the following components.

A digital picture processor comprises a camera interface (hereinafter, referred to as a CCD interface) 311, a scaler 313, a converter 315, a display interface (hereinafter, referred to as an LCD interface) 317 and a first line buffer 318. The digital picture processor performs an interface function for the image signals between the camera 50 and the display unit 80. Typically, the number of pixels of the image signals of one screen received from the camera 50 is different from the number of pixels of image signals of a screen capable of being displayed on the display unit 80. Accordingly, the digital picture processor performs the interface function for the image signals between the camera 50 and the display unit 80. In an embodiment of the present invention, the digital picture processor scales image data of YUV 422 format-based 16 bits received from the signal processor 60, and reduces and crops the image data to a size of 128×112 or 128×96 pixels by cutting upper, lower, left and right ends of a picture corresponding to the image data. It is assumed that the digital picture processor converts the processed image data in an RGB 444 format and then transmits the converted image data to the display unit 80.

The CCD interface 311 of the digital picture processor performs an interface function for a YUV 422 (16 bits) format picture and synchronous signals HREF and VREF received from the signal processor 60. In an embodiment of the invention, the HREF and VREF signals can be generated from the CCD interface 311 and provided to the signal processor 60. The HREF is used as a horizontal valid time flag and a line synchronous signal. The HREF is a signal for reading the image data, stored in a line memory, in units of lines. The line memory is located in the digital processor 215 contained in the signal processor 60. The VREF is used as a vertical valid time flag and a frame synchronous signal. The VREF is also used as a signal for enabling the signal processor 60 to output data of the image signals captured by the camera 50.

The LCD interface 317 of the digital picture processor can access the image data of the controller 10 and the digital picture processor using a switching function of a selector 319. In FIG. 4, LD<15:0> indicates a data bus. Except when data is read from the display unit 80 or LRD is asserted, the data bus is directed to an output operation. LA, LCS, LWR and LRD are an address signal, a selection signal for the display unit 80, a write signal and a read signal, respectively.

The image codec 350 is comprises a line buffer interface 325, a second line buffer 327, a JPEG pixel interface 329, a JPEG controller 331, a JPEG core bus interface 333 and a JPEG code buffer 335. In an embodiment of the invention, the JPEG processor can be a JPEG codec. The image codec 350 compresses the image data received from the signal processor 60 in a JPEG format to output code data to the controller 10, or decompresses compressed code data received from the controller 10 in the JPEG format to output the decompressed data to the digital picture processor. In an embodiment of the present invention, the image codec 350 compresses YUV 422 format-based image data, based on a common intermediate format (CIF) size, received from the CCD interface 311 or compresses scaled and cropped image data of a size of 128×112 or 128×96 pixels in the JPEG format, and then outputs code data. Code data received from the controller 10 is decompressed in the JPEG format and then the decompressed data is transmitted to the digital picture processor.

An operation of the image codec 350 will now be described.

The line buffer interface 325 applies the YUV 422 format-based image data received from the CCD interface 311 to the second line buffer 327. The second line buffer 327 buffers or stores the received image data in units of lines. The JPEG pixel interface 329 transfers, to the JPEG controller 331, the image data stored in the second line buffer 327 in units of lines. The JPEG controller 331 compresses the received image data and then outputs the compressed image data to the bus interface 333. Then, the JPEG controller 331 decompresses the compressed image data received from the bus interface 333 and then outputs the decompressed data to the pixel interface 329. The bus interface 333 performs an interface between the JPEG controller 331 and the JPEG code buffer 335. The JPEG code buffer 335 buffers the JPEG image data received from the controller 10 through the JPEG controller 331 and the control interface 321.

An operation of enabling the controller 10 to access the JPEG code buffer 335 will now be described.

The code buffer 335 is used for JPEG code data of the image processor 70, and has a built-in memory. The memory is used as a buffer for outputting compressed and encoded image data when the JPEG controller 331 performs an encoding mode. Further, the memory is used as a buffer for receiving JPEG compressed image data when the JPEG controller 331 performs a decoding mode. The JPEG controller 331 and the controller 10 can exclusively access the code buffer 335. That is, where the JPEG controller 331 performs the encoding mode and the decoding mode, the controller 10 cannot access the JPEG code buffer 335. The controller 10 controls the selection of a right to access the JPEG code buffer 335. The controller 10 issues a control command to an internal register of the image processor 70, and the right to access the JPEG code buffer 335 is given to the controller 10 or the JPEG controller 331.

After the controller 10 provides the JPEG controller 331 the right to access the JPEG code buffer 335, a JPEG encoding operation is initiated. The CCD interface 311 receives image data if a VREF signal is generated. The JPEG controller 331 performs the JPEG encoding operation for the received image data. If the JPEG encoding operation is completed, the right to access the JPEG code buffer 335 is given to the controller 10. Contents of the JPEG code buffer 335 are sequentially read from the head (address 0) of the buffer 335 in a unit of 16 bits through internal register entries.

In the decoding mode, the controller 10 sequentially stores JPEG code data from the head (address 0) of the buffer 335. The storage of the JPEG code data is performed in the unit of 16 bits through the internal register entries. If the JPEG code data corresponding to one screen (or one frame) is completely stored in the JPEG code buffer 335, the right to access the JPEG code buffer 335 is switched to the JPEG controller 331. Then, a JPEG decoding operation is initiated.

In the decoding mode, an image output path directed to the display unit 80 must be switched to a JPEG output. Further, a right to use an output path directed to the display unit 80 is necessary to be switched to the image processor 70. A register of the display unit 80 must be set such that image data from the image processor 70 can be entered in a memory of the display unit 80. The code buffer 335 is used to buffer JPEG code data corresponding to one screen.

The thumbnail generator 360 includes a thumbnail resizer 337 and a thumbnail buffer 339. The thumbnail generator 360 configures a set of thumbnail pictures from the image data output by the digital picture processor. In an embodiment of the present invention, it is assumed that image data of 128×112 or 128×96 pixels is reduced to a picture of 40×40.

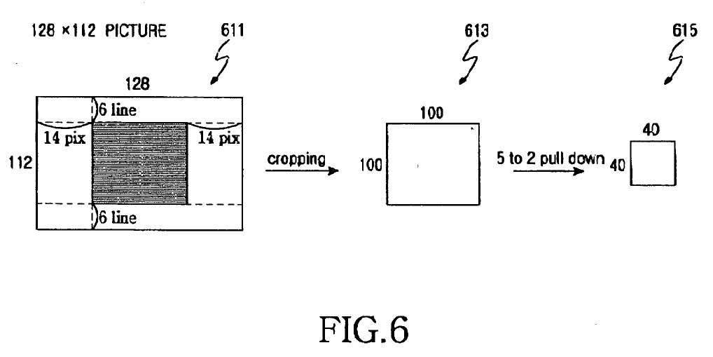

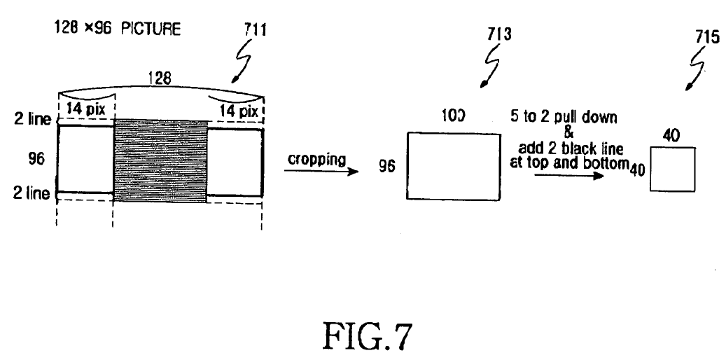

In an embodiment of the present invention, an operation of generating the thumbnail picture will now be described with reference to FIGS. 6 and 7.

FIG. 6 is a diagram illustrating an example of a displayed thumbnail picture in accordance with an embodiment of the present invention and FIG. 7 is a diagram illustrating another example of a displayed thumbnail picture in accordance with an embodiment of the present invention.

Referring to FIG. 6, when image data of a display picture scaled by the scaler 313 consists of 128×112 pixels as indicated by reference numeral 611, the thumbnail resizer 337 removes 14 pixels at each of left and right ends of the display picture and then removes 6-line pixels at each of upper and lower ends of the display picture such that a picture of 100×100 pixels is created. The picture of 100×100 pixels as indicated reference numeral 613 shown in FIG. 6 is then reduced to a thumbnail picture of 40×40 pixels as indicated by reference numeral 615 shown in FIG. 6 according to a 5-2 pull down scheme.

Referring now to FIG. 7, when image data of a display picture scaled by the scaler 313 consists of 128×96 pixels as indicated by reference numeral 711, the thumbnail resizer 337 removes 14 pixels at each of left and right ends of the display picture as indicated by reference numeral 713. Accordingly, the picture consisting of 100×96 pixels is created. Since the number of lines of the picture does not reach 100 lines, a thumbnail picture of 40×40 pixels indicated by reference numeral 715 shown in FIG. 7 is created by the 5-2 pull down scheme after the thumbnail resizer 337 processes two top and bottom lines in the form of black lines.

The control interface 321 performs an interface function between the image processor 70 and the controller 10, and between the display unit 80 and the controller 10. That is, the control interface 321 serves as a common interface for accessing the internal register of the image processor 70, the JPEG code buffer 335, and the thumbnail buffer 339 and for accessing the display unit 80 through the image processor 70. D<15:0> and A<1:0> of FIG. 4 indicate a data bus and an address bus, respectively. CS, WR, RD and SEL refer to a selection signal for the image processor 70 and the display unit 80, a write signal, a read signal and a path control signal for the selector 319, respectively.

In response to a path control signal output from the controller 10, the selector 319 selects data output from the image processor 70 or data output from the controller 10, and outputs the data to the display unit 80. A first path control signal refers to a signal for activating a bus between the image processor 70 and the display unit 80, and a second path control signal refers to a signal for activating a path between the controller 10 and the display unit 80. Moreover, the controller 10 enables the display unit 80 to perform two-way communication through the selector 319.

An I2C interface 323 allows the controller 10 to directly access the signal processor 60. That is, the I2C interface 323 controls the signal processor 60, and the controller 10 can access the signal processor 60 irrespective of the I2C interface 323, as in the case where data is read from a conventional register or written to the conventional register. SDA associated with the I2C interface 323 is I2C data for a CCD module, which is exchanged with the signal processor 60. SCL associated with the I2C interface 323 is an I2C clock for the CCD module.

An operation of the digital picture processor will be described with reference to FIG. 4. The CCD interface 311 performs an interface function for the image data output by the signal processor 60. Here, the image data is based on YUV 422 (16 bits) and fixed to a CIF of 352×288 pixels. In accordance with an embodiment of the present invention, the scaler 313 scales data of the image signals captured by the camera 50 in response to a control signal received from the controller 10, such that the scaled image data is displayed on the display unit 80. That is, the number of pixels of the image signals received from the camera 50 corresponds to the CIF size of 352×288, and the number of pixels of image signals capable of being displayed on the display unit 80 corresponds to a size of 128×112 or 128×96. Thus, the scaler 313 reduces and crops the pixels of the image signals received from the camera 50 to provide the number of the image signal pixels capable of being displayed on the display unit 80. Moreover, the scaler 313 can enlarge the pixels of the image signals received from the camera 50 such that the enlarged pixels can be displayed. In a method for enlarging and displaying the pixels, the pixels of the image signals received from the camera 50 are selected by the number of pixels capable of being displayed on the display unit 80 and the selected image signal pixels can be displayed. The color converter 315 converts YUV data received from the scaler 313 into RGB data and then outputs the RGB data. The LCD interface 317 performs an interface function for the image data of the display unit 80. The first line buffer 318 performs buffering for the image data interfaced between the LCD interface 317 and the display unit 80.

An operation of capturing image signals through the camera 50 and displaying the captured image signals on the display unit 80 will now be described.

First, an operation of transmitting the image signals captured by the camera 50 to the display unit 80 will be described.

The image processor 70 controls a transmission rate of image data received from the signal processor 60, and stores the received image data in the memory of the display unit 80 through the LCD interface 317. A size of pixels of the image signals received from the CCD image sensor is a CIF size of 352×288. The pixels of the image signals are reduced and partially removed (or cropped) such that the number of pixels (128×112 or 128×96) capable of being displayed on the display unit 80 is provided. The scaler 313 of the image processor 70 removes some pixels or selects pixels of a specified area such that the pixels received from the signal processor 60 can be displayed on the display unit 80. A flow of image data through the signal processor 60, the image processor 70 and the display unit 80 is affected by an access rate for the display unit 80. Thus, the LCD interface 317 supports temporarily buffering the data in the first line buffer 318 such that a rate of the image data to be read from the signal processor 60 and a rate of the image data to be written to the display unit 80 can be adjusted.

The scaler 313 of the digital picture processor performs a scaling the number of pixels of image signals captured by the camera 50 to the number of pixels of image signals capable of being displayed on the display unit 80. That is, the number of the pixels of the image signals corresponding to one frame captured by the camera 50 is different from the number of the pixels of the image signals corresponding to one frame capable of being displayed on the display unit 80. The situation will be described where the number of the pixels of the image signals corresponding to one frame captured by the camera 50 is larger than the number of the pixels of the image signals corresponding to a frame capable of being displayed on the display unit 80. In this case, the number of pixels corresponding to one frame captured by the camera 50 is reduced to the number of pixels corresponding to a frame capable of being displayed on the display unit 80. There can be used a method for appropriately setting the number of pixels of one frame and displaying the set number of pixels on the display unit 80. When the number of the pixels is reduced, resolution can be degraded. On the other hand, when the number of pixels is appropriately set, pixels of a specified area can be selected from the captured image and hence an image of the selected pixels can be enlarged or zoomed out with keeping an appropriate resolution.

Otherwise, the number of pixels corresponding to one frame capable of being displayed on the display unit 80 can be larger than the number of pixels corresponding to a frame captured by the camera 50. In this case, an interpolating method for inserting pixels between pixels of the image signals captured by the camera 50 can be used. Pixels having an interpolated intermediate value can be inserted between the pixels of the image signals captured by the camera 50. Further, the pixels having the interpolated intermediate value can be inserted between lines.

A method for reducing an original image will now be described.

In an embodiment of the present invention, when the image data is transmitted from the signal processor 60 to the display unit 80, the image data is horizontally and vertically reduced such that 352×288 pixels corresponding to an CIF image received from the signal processor 60 can be inserted into a display area.

The following Table 1 shows zoom-ratio setting commands for controlling the scaler 313. As shown in Table 1, a vertical/horizontal zoom-ratio setting command requires a parameter of one word. The scaler 313 must include a straight-line interpolation filter in a horizontal direction and a device for extracting and processing pixels in a vertical direction. In an embodiment of the present invention, picture processing can be horizontally and vertically adjustable in 256 steps of 1/256˜256/256.

TABLE 1
SCALE parameter (R/W)

| A<1:0> | D<15:8> | D<7:0> | Default |
|---|---|---|---|
| 3h | H_SCALE | V_SCALE | 6464h |
| | <7:0> | <7:0> | |

In Table 1, H_SCALE is a scale ratio setting parameter in a horizontal direction, and a scale ratio=(H_SCALE+1)/256. V_SCALE is a scale ratio setting parameter in a vertical direction and a scale ratio=(V_SCALE+1)/256. For example, where H_SCALE=V_SCALE=150, (150+1)/256=0.5898. In this case, reduction processing of “×0.5898” for an original image (CIF: 352×288) is carried out.

An operation of selecting pixels corresponding to a display area of the display unit 80 and performing a zoom function will now be described. In this case, horizontal and vertical valid sections must be set.

The following Table 2 shows a command (HRANG) for setting a horizontal display initiation position/valid display section. The command requires a parameter of one word. After a scaling operation is performed in response to the command parameter as shown in Table 2, a corresponding picture is horizontally cropped to be appropriate to a display size of the display unit 80.

TABLE 2
HRANG parameter (R/W)

| A<1:0> | D<15:8> | D<7:0> | Default |
|---|---|---|---|
| 3h | H_ST<7:0> | H_VAL<7:0> | 240h |

In Table 2, H_ST is a parameter for setting a display initiation position in the horizontal direction, and H_VAL is a parameter for setting a valid display section in the horizontal direction. Actual values of H_ST and H_VAL are a set value ×2, respectively.

The following Table 3 shows a command (VRANG) for setting a vertical display initiation position/valid display section. The command requires a parameter of one word. After a scaling operation is performed in response to the command parameter, a corresponding picture is vertically cropped to be appropriate to a display size of the display unit 80.

TABLE 3
VRANG parameter (R/W)

| A<1:0> | D<15:8> | D<7:0> | Default |
|---|---|---|---|
| 3h | V_ST<7:0> | V_VAL | 0038h |
| | | <7:0> | |

In Table 3, V_ST is a parameter for setting a display initiation position in the vertical direction, and V_VAL is a parameter for setting a valid display section in the vertical direction. Actual values of V_ST and V_VAL are a set value ×2, respectively.

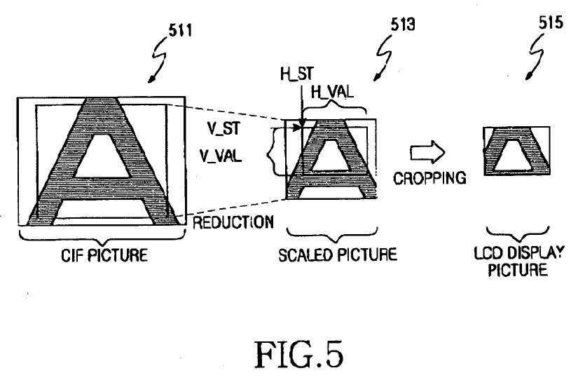

Thus, where the signal processor 60 outputs image data as indicated by reference numeral 511 shown in FIG. 5, a scaled picture as indicated by reference numeral 513 shown in FIG. 5 is generated and a display picture as indicated by reference numeral 515 shown in FIG. 5 is generated by cropping the scaled picture, if the horizontal valid section associated with the above Table 2 and the vertical valid section associated with the above Table 3 are set.

When the number of pixels of image signals corresponding to one screen captured by the camera 50 is different from the number of pixels of image signals corresponding to a screen capable of being displayed, the controller 10 generates a first scale control signal for reducing the pixels of the image signals captured by the camera 50 in response to the user's selection and displaying the reduced pixels on the entire screen of the display unit 80, and a second scale control signal for selecting a predetermined pixel area of the image signals captured by the camera 50 and displaying the selected pixel area on a zoom screen. In response to the first or second scale control signal, the scaler 313 reduces the pixels of the image signals captured by the camera 50 or selects a predetermined pixel area of the image signals captured by the camera 50 containing pixels capable of being displayed on the display unit 80, such that the scaler 313 outputs the reduced pixels or the selected pixels.

Hereinafter, it is assumed that the camera 50 is mounted in the mobile communication terminal.

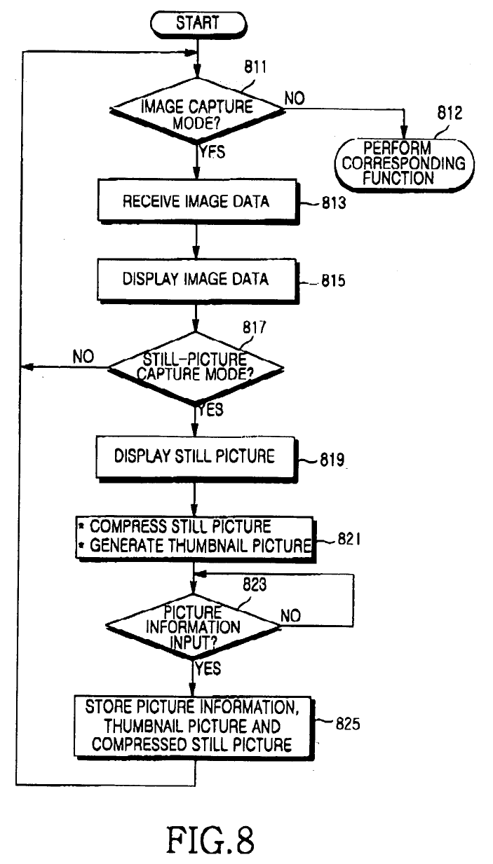

FIG. 8 is a flow chart illustrating an example of steps for generating a thumbnail picture from the image signals captured by the camera 50 and storing the thumbnail picture along with image data of a main picture in accordance with an embodiment of the present invention.

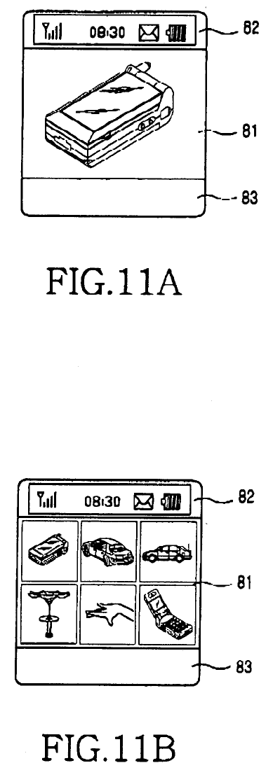

Referring to FIG. 8, when an image of captured image signals is displayed on the display unit 80, the user generates key data for driving the camera 50 through the key input unit 27. A key for operating an image capture mode can be arranged on a navigation key of the key input unit 27. In an embodiment of the present invention, the key for driving the image capture mode can be displayed and selected as a menu item using a menu key. When the image capture mode is selected, the controller 10 detects the selected image capture mode at step 811. If the image capture mode is not selected, the method proceeds to step 812 where corresponding functions are performed. At steps 813 and 815, the controller 10 controls a display data path to receive image data output from the image processor 70 and user data output from the controller 10 and displays the data on the display unit 80. As shown in FIGS. 11A and 11B, the display unit 80 displays the image data output from the image processor 70 on a display area 81, displays general information such as reception sensitivity, a current time, a remaining amount of a battery power, etc. on a display area 82, and displays user data for indicating a menu of various modes selectable by the user in the image capture mode on a display area 83.

When the preview screen is displayed at step 815, image data of the image signals captured by the camera 50 is displayed as a moving picture, and the user data output from the controller 10 is displayed. Further, the JPEG controller 331 compresses and encodes image data of the displayed main picture in the JPEG format, and then stores the compressed and encoded image data in the code buffer 335. Moreover, the thumbnail resizer 337 generates image data of a thumbnail picture from display data scaled by the scaler 313 as shown in FIGS. 6 and 7, and then stores the generated thumbnail picture data in the thumbnail buffer 339.

As described, when the preview screen is displayed on the display unit 80, the user can identify the displayed moving picture and then generate a still-picture capture command for capturing a still picture at a specified time point. The still-picture capture command can be implemented using a specified key arranged on the key input unit 27. In an embodiment of the invention, the still-picture capture command can be selected using a menu displayed on the display area 83 of the display unit 80. If the still-picture capture command is generated, the controller 10 detects the generated still-picture capture command at step 817 and then controls the image processor 70 such that a still picture is captured from the currently displayed image screen and the captured still picture is displayed on the display unit 80 at step 819. Then, at step 821, the controller 10 performs a control operation such that image data of a main picture can be compressed and encoded to be stored in the code buffer 335 and the image data of the thumbnail picture can be generated and stored in the thumbnail buffer 339. Moreover, the controller 10 reads the image data of the main picture compressed and encoded in the JPEG format stored in the code buffer 335 and the image data of the thumbnail picture stored in the thumbnail buffer 339. The controller 10 waits for an input of information corresponding to the image data of the main picture and the image data of the thumbnail picture. The information can be a name of the picture, and so on. If the information of the picture is input at step 823, the controller 10 detects the input picture information, and stores the picture information, the image data of the main picture and the image data of the thumbnail picture in the memory 30 at step 825. The method returns to the above step 811.

If the method shown in FIG. 8 is performed, the mobile communication terminal compresses and encodes the image data of the image signals captured by the camera 50 and generates the image data of the thumbnail picture. The mobile communication terminal stores the image data of the main picture, the image data of the thumbnail picture, the picture name, a picture capture date, etc. in the memory 30.

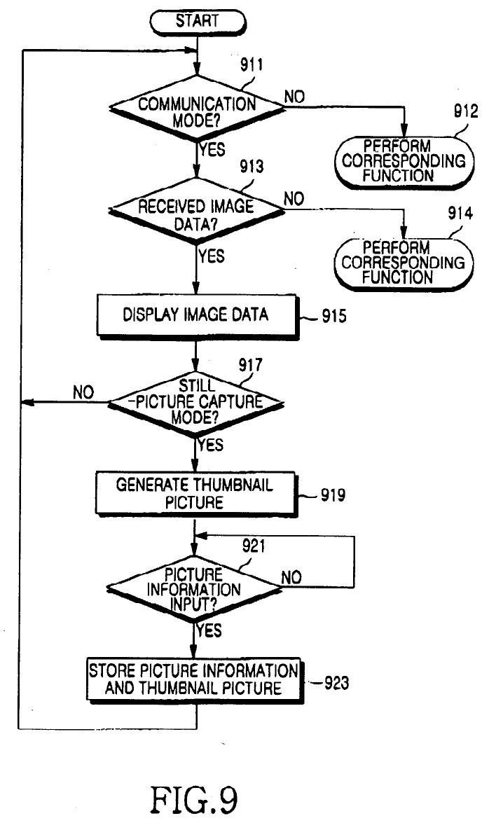

FIG. 9 is a flow chart illustrating another example of steps for generating a thumbnail picture from image data transmitted by a base station and storing the generated thumbnail picture along with image data of a main picture in accordance with an embodiment of the present invention.

Referring to FIG. 9, if the mobile communication terminal receives image data from the base station in a communication mode, the controller 10 detects the received image data at steps 911 and 913. If the controller 10 does not detect the communication mode or received image data at steps 911 or 913, the method proceeds to steps 912 or 914 where corresponding functions are performed. The display unit 80 displays the received image data and user data at step 915. The image data received from the base station can be image data compressed and encoded in the JPEG format. Thus, the controller 10 stores the received data in the memory 30 and the JPEG code buffer 335, and drives the JPEG controller 331. Moreover, the controller 10 controls the selector 319 to control a bus for transmitting an output of the image processor 70 to the display unit 80. The JPEG controller 331 decompresses and decodes JPEG image data stored in the code buffer 335 and then applies the decompressed and decoded JPEG image data to the scaler 313. Then, the scaler 313 scales the image data and then transmits the scaled image data to the display unit 80 such that the scaled image data can be displayed. As shown in FIGS. 11A and 11B, the display unit 80 displays the received image data on a display area 81, displays general information such as reception sensitivity, a current time, a remaining amount of a battery power, and so on. On a display area 82, and displays user data for indicating a menu of various modes selectable by the user in the image capture mode on a display area 83. Moreover, the thumbnail resizer 337 generates thumbnail picture data from display screen data scaled by the scaler 313 as shown in FIGS. 6 and 7, and then stores the generated thumbnail picture data in the thumbnail buffer 339.

As described, when the received image data and the user data are displayed on the display unit 80, a still-picture capture command can be generated. The still-picture capture command can be implemented using a specified key arranged on the key input unit 27. Moreover, the still-picture capture command can be selected using a menu displayed on the display area 83 of the display unit 80. If the still-picture capture command is not generated at step 917, the method returns to step 911. If the still-picture capture command is generated, the controller 10 detects the generated still-picture capture command at step 917. Then, at step 919, the controller 10 performs a control operation such that the image data of the thumbnail picture can be generated and stored in the thumbnail buffer 339. Moreover, the controller 10 reads the image data of the thumbnail picture stored in the thumbnail buffer 339. The controller 10 waits for an input of information corresponding to image data of a main picture and the image data of the thumbnail picture. The information can be a name of the picture, and so on. If the picture information is not input at step 921, the method repeats until the picture information is input. If the information of the picture is input at step 921, the controller 10 detects the input picture information, and stores the picture information, the image data of the main picture and the image data of the thumbnail picture in the memory 30 at step 923. The method returns to the above step 911.

If the method shown in FIG. 9 is performed, the mobile communication terminal stores and displays the image data received from the base station and generates the image data of the thumbnail picture from the image data of the displayed main picture. The mobile communication terminal stores the image data of the main picture, the image data of the thumbnail picture, the picture name, a picture capture date, etc. in the memory 30.

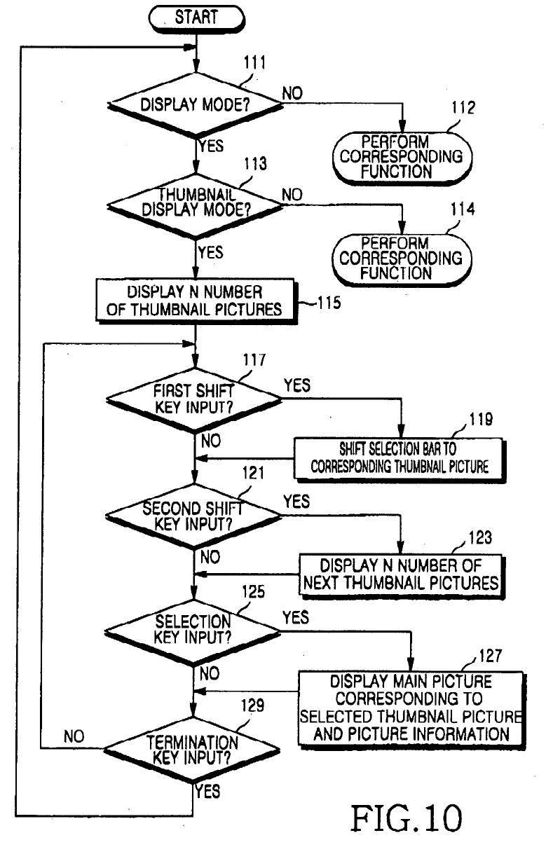

FIG. 10 is a flow chart illustrating an example of steps for displaying a generated thumbnail picture by the procedures shown in FIGS. 8 and 9, and selecting a main picture from the generated thumbnail picture in accordance with an embodiment of the present invention.

Referring to FIG. 10, if there is selected a mode for displaying image data of at least one thumbnail picture stored in the memory 30, the controller 10 detects the selected thumbnail display mode by performing steps 111 and 113. If the display mode and thumbnail mode were not detected in steps 111 or 113, the method proceeds to steps 112 or 114 where corresponding functions are performed. At step 115, the controller 10 accesses image data of N number of thumbnail pictures stored in the memory 30, and transmits the accessed image data to the display unit 80. In other words, if the thumbnail display mode is selected, the controller 10 accesses a plurality of thumbnail pictures and performs a control operation such that the display unit 80 can simultaneously display the plurality of thumbnail pictures. FIG. 11B shows thumbnail pictures displayed in the thumbnail display mode. In FIG. 11B, it is assumed that N is 6. As shown in FIG. 11B, the display unit 80 can display the six thumbnail pictures on the display area 81, display user information such as a current time, etc. On the display area 82, and display a menu for selecting the thumbnail pictures on the display area 83.

When the thumbnail pictures are displayed as shown in FIG. 11B, the user can select a specific thumbnail picture. To select the specific thumbnail picture, the user can shift a selection bar to the specific thumbnail picture on the display unit 80 using first shift keys (e.g., navigation keys) capable of shifting the selection bar in up, down, left and right directions. N number of next thumbnail pictures can be selected using a second shift key. Thus, if the first shift key is input at step 117, the controller 10 shifts the selection bar to the selected thumbnail picture by controlling the display unit 80 at step 119. Then, if the second shift key is input at step 121, the controller 10 performs a control operation such that N number of next thumbnail pictures stored in the memory 30 can be selected and displayed on the display unit 80 at step 123.

If a selection key is input after desired thumbnail pictures are selected using the first and second shift keys, the controller 10 detects the input selection key at step 125 and then accesses main picture data and picture information corresponding to the selected thumbnail picture stored in the memory 30 at step 127. Then, the accessed main picture data and the picture information are supplied to the display unit 80. If so, the image data of the main picture is displayed on the display area 81 of the display unit 80 through the image processor 70. The picture information is displayed on the display area 83. As described, when the image data of the main picture is selected using the thumbnail picture, if a termination key is input, the controller 10 detects the input termination key at step 129. The method returns to the above step 111. If the termination key input was not detected in step 129, the method returns to step 117.

As described, when data of image signals received from the camera 50 or image data received from the base station is displayed on the display unit 80, image data of a thumbnail picture corresponding to a displayed main picture is generated. The mobile communication terminal receives input picture information associated with the image data of the main picture and thumbnail picture and then stores the input picture information along with the main picture in the memory 30. The data and information are stored in the memory 30 such that the image data of the main picture and thumbnail picture can be mapped to the input information. If the user selects the thumbnail display mode, a plurality of thumbnail pictures are accessed and the accessed thumbnail pictures are displayed on the display unit 80. Moreover, if a desired thumbnail picture of the displayed thumbnail pictures is selected, image data of a main picture corresponding to the selected thumbnail picture and the picture information are displayed on the display unit 80. Accordingly, the user can readily select image data stored in the mobile communication terminal with the camera 50.

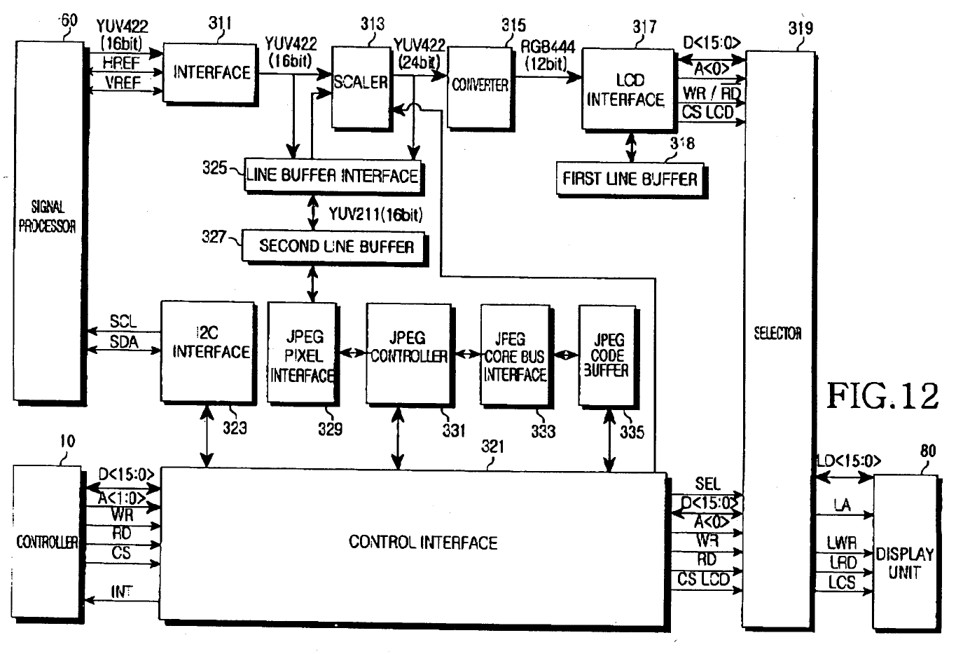

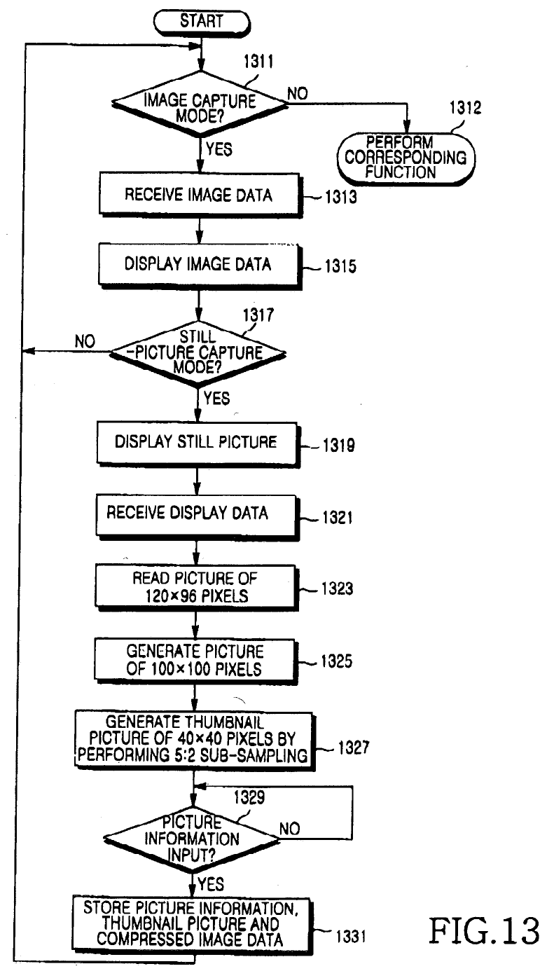

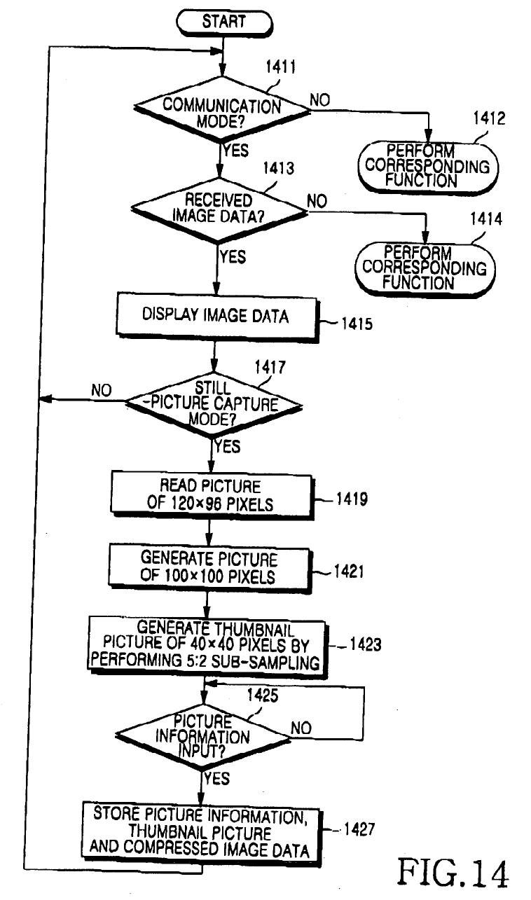

FIGS. 12 to 14 are diagrams illustrating operations for generating at least one thumbnail picture in accordance with another embodiment of the present invention. Specifically, FIG. 12 is a block diagram illustrating another example of components of the image processor shown in FIG. 1 in accordance with an embodiment of the present invention; FIG. 13 is a flow chart illustrating an example of steps for generating at least one thumbnail picture in the mobile communication terminal with the image processor shown in FIG. 12 in accordance with an embodiment of the present invention; and FIG. 14 is a flow chart illustrating another example of steps for generating the thumbnail picture in the mobile communication terminal with the image processor shown in FIG. 12 in accordance with an embodiment of the present invention.

The image processors 70 shown in FIGS. 3A and 3B include the thumbnail generator 360, respectively. The thumbnail generator 360 generates a thumbnail picture corresponding to image data of a still picture selected in a still-picture capture mode. However, where the image processor 70 of the mobile communication terminal does not include the thumbnail generator 360, image data of a thumbnail picture can be generated. FIG. 12 shows a configuration of the image processor 70 without the thumbnail generator 360. That is, the image processor 70 processes the thumbnail picture of FIG. 4, but the controller 10 generates the thumbnail picture in FIG. 12 such that the thumbnail resizer 337 and the thumbnail buffer 339 included in the thumbnail generator 360 are removed from the image processor 70. Thus, the configuration of FIG. 12 is different from that of FIG. 4 in that the thumbnail generator 360 is removed from FIG. 12. An operation of the image processor 70 shown in FIG. 12 is similar to that of the image processor 70 shown in FIG. 4.

Referring to FIG. 13, when an image of captured image signals is displayed on the display unit 80, the user generates key data for driving the camera 50 through the key input unit 27. When an image capture mode is selected, the controller 10 detects the selected image capture mode at step 1311. If the image capture mode was not detected, the method proceeds to step 1312 where corresponding functions are performed such as voice communication, data communication and so on. At steps 1313 and 1315, the controller 10 controls a display data path to receive image data output from the image processor 70 and user data output from the controller 10 and then to display the data on the display unit 80. As shown in FIGS. 11A and 11B, the display unit 80 displays the image data output from the image processor 70 on a display area 81, displays general information such as reception sensitivity, a current time, a remaining amount of a battery power, and so on. On a display area 82, and displays user data for indicating a menu of various modes selectable by the user in the image capture mode on a display area 83.

When a preview screen is displayed at the above step 1315, image data of the image signals captured by the camera 50 is displayed as a moving picture, and the user data output from the controller 10 is displayed. Further, the JPEG controller 331 compresses and encodes image data of the displayed main picture in the JPEG format, and then stores the compressed and encoded image data in the code buffer 335.

As described, when the preview screen is displayed on the display unit 80, the user can identify the displayed moving picture and then generate a still-picture capture command for capturing a still picture at a specified time point. If the still-picture capture command is generated, the controller 10 detects the generated still-picture capture command at step 1317 and then controls the image processor 70 such that a still picture is captured from the currently displayed image screen and the captured still picture is displayed on the display unit 80 at step 1319. If the still picture capture mode was not detected, then the method returns to step 1311. At step 1321, the controller 10 reads the image data of the main picture compressed and encoded in the JPEG format stored in the code buffer 335.

The controller 10 reads image data displayed on the display unit 80 at the above step 1321. The size of the displayed image data can be 120×96 pixels or 128×112 pixels. It is assumed that the displayed image data corresponds to 120×96 pixels. At step 1323, the controller reads the image data of 120×96 pixels. Then, at step 1325, the controller 10 removes 10 pixels at each of left and right ends of the displayed image data and inserts two lines at each of top and bottom of the displayed image data such that a picture of 100×100 pixels is generated. At step 1327, the image data of 100×100 pixels is reduced to a thumbnail picture of 40×40 pixels by performing a 5:2 sub-sampling operation (a 5-2 pull down scheme). The thumbnail picture of 40×40 pixels is stored in the memory 30.

Then, the controller 10 waits for an input of information corresponding to the image data of the main picture and the image data of the thumbnail picture. The information can be a name of the picture, etc. If the information of the picture is input, the controller 10 detects the input picture information at step 1329, and stores the picture information, the image data of the main picture and the image data of the thumbnail picture in the memory 30 at step 1331. The method returns to step 1311.

If the method shown in FIG. 13 is performed, the mobile communication terminal compresses and encodes the image data of the image signals captured by the camera 50 and generates the image data of the thumbnail picture. The mobile communication terminal stores the image data of the main picture, the image data of the thumbnail picture, the picture name, a picture capture date, etc. in the memory 30.

Referring to FIG. 14, if the mobile communication terminal receives image data from the base station in a communication mode, the controller 10 detects the received image data at steps 1411 and 1413. If the communication mode or the received image data were not detected at steps 1411 and 1413, the method proceeds to steps 1412 and 1414 where corresponding functions are performed such as voice communication, data communication and so on. The display unit 80 displays the received image data and user data at step 1415. The image data received from the base station can be image data compressed and encoded in the JPEG format. Thus, the controller 10 stores the received data in the memory 30 and the JPEG code buffer 335 and drives the JPEG controller 331. Moreover, the controller 10 controls the selector 319 to control a bus for transmitting an output of the image processor 70 to the display unit 80. If so, the JPEG controller 331 decompresses and decodes JPEG image data stored in the code buffer 335 and then applies the decompressed and decoded JPEG image data to the scaler 313. Then, the scaler 313 scales the image data and then transmits the scaled image data to the display unit 80 such that the scaled image data can be displayed. As shown in FIGS. 11A and 11B, the display unit 80 displays the received image data on a display area 81, displays general information such as reception sensitivity, a current time, a remaining amount of a battery power, and so on. On a display area 82, and displays user data for indicating a menu of various modes selectable by the user in the image capture mode on a display area 83.

As described, when the received image data and the user data are displayed on the display unit 80, a still-picture capture command can be generated. The still-picture capture command can be implemented using a specified key arranged on the key input unit 27. Moreover, the still-picture capture command can be selected using a menu displayed on the display area 83 of the display unit 80. If the still-picture capture command is generated, the controller 10 detects the generated still-picture capture command at step 1417. If the still picture capture mode was not detected at step 1417, the method returns to step 1411. At step 1419, the controller 10 reads the image data displayed on the display unit 80. The size of the displayed image data can be 120×96 pixels or 128×112 pixels. It is assumed that the displayed image data corresponds to 120×96 pixels. At step 1421, the controller 10 removes 10 pixels at each of left and right ends of the displayed image data and inserts two lines at each of top and bottom of the displayed image data such that a picture having a size of 100×100 pixels is generated. At step 1423, the image data of 100×100 pixels is reduced to a thumbnail picture of 40×40 pixels by performing a 5:2 sub-sampling operation (a 5-2 pull down scheme). The thumbnail picture of 40×40 pixels is stored in the memory 30.

The controller 10 waits for an input of information corresponding to image data of a main picture and the image data of the thumbnail picture. The information can be a name of the picture, etc. If the picture information input is not detected by the controller 10, step 1425 is repeated until the picture information is input. If the information of the picture is input, the controller 10 detects the input picture information at step 1425, and stores the picture information, the image data of the main picture and the image data of the thumbnail picture in the memory 30 at step 1427. The method returns to step 1411.

If the method shown in FIG. 14 is performed, the mobile communication terminal stores and displays the image data received from the base station and generates the image data of the thumbnail picture from the image data of the displayed main picture. The mobile communication terminal stores the image data of the main picture, the image data of the thumbnail picture, the picture name, a picture capture date, etc. in the memory 30.

As described, when data of image signals received from the camera 50 or image data received from the base station is displayed on the display unit 80, image data of a thumbnail picture corresponding to a displayed main picture is generated. The mobile communication terminal receives input picture information associated with the image data of the main picture and thumbnail picture and then stores the input picture information along with the main picture in the memory 30. The data and information are stored in the memory 30 such that the image data of the main picture and thumbnail picture can be mapped to the input information. If the user selects the thumbnail display mode, a plurality of thumbnail pictures are accessed and the accessed thumbnail pictures are displayed on the display unit 80. Moreover, if a desired thumbnail picture of the displayed thumbnail pictures is selected, image data of a main picture corresponding to the selected thumbnail picture and the picture information are displayed on the display unit 80. Accordingly, the user can readily select image data stored in the mobile communication terminal with the camera 50.

Although embodiments of the present invention have been disclosed for illustrative purposes, those skilled in the art will appreciate that various modifications, additions and substitutions are possible, without departing from the scope of the invention. Accordingly, the present invention is not limited to the above-described embodiments, but the present invention is defined by the claims which follow, along with their full scope of equivalents.

What is claimed is:

1. A device for displaying an image in a mobile communication terminal, comprising:
a camera for capturing an object's image and generating image data;
a display data processor for processing the image data generated by the camera on the basis of a display standard;
an image codec for compressing the image data processed by the display data processor and generating image data of at least one still picture in a still-picture capture mode;
a thumbnail generator for generating image data of at least one thumbnail picture of a set size from the image data processed by the display data processor in the still-picture capture mode;
a user data generator for generating user data according to a display mode;
a display unit for displaying the image data on a first display area and displaying the user data on a second display area; and
a controller for cutting off a path of the image data by controlling the display data processor in the still-picture capture mode, driving the image codec and the thumbnail generator such that the image data displayed on the first display area can be compressed, storing the image data compressed by the image codec as the still picture, and storing the image data generated by the thumbnail generator as the thumbnail picture.

2. The device as set forth in claim 1, wherein the display data processor comprises:
a scaler for scaling the image data output from the camera to a display size of the display unit.

3. The device as set forth in claim 2, wherein the image processor further comprises:
a color converter connected to an output terminal of the scaler for performing a color format conversion where the camera outputs image data based on a YUV format and the display unit displays image data based on an RGB format.

4. The device as set forth in claim 2, wherein the image processor further comprises:
a color converter connected to an input terminal of the scaler for performing a color format conversion where the camera outputs image data based on a YUV format and the display unit displays image data based on an RGB format.

5. The device as set forth in claim 1, wherein the user data generator generates first user data for indicating a release of the image capture mode, and second user data for indicating at least one of a remaining amount of a battery power of the mobile communication terminal, reception sensitivity, and time information in the image capture mode.

6. The device as set forth in claim 5, wherein the display unit comprises:
the first display area for displaying the image data; and
the second display area for displaying the second user data at an upper portion of the first display area, and displaying the first user data at a lower portion of the first display area.

7. A method for displaying an image in a mobile communication terminal, the mobile communication terminal including a camera for capturing an object's image and generating image data, a user data generator for generating user data according to a display mode, and a display unit for displaying the image data on a first display area and displaying the user data on a second display area, the method comprising the steps of:
transmitting the image data generated by the camera and the user data generated by the user data generator to the first and second display areas of the display unit in an image capture mode, and displaying a moving picture; and
when a still-picture capture command is generated in the image capture mode, compressing and encoding the image data displayed on the first display area of the display unit, generating image data of at least one still picture and image data of at least one thumbnail picture of a set size, and storing the generated image data.

8. The method as set forth in claim 7, further comprising the step of:
when the still-picture capture command is generated, displaying at least one of the user data for registering a still-picture name, a name of a place in which the still picture is captured on the second display area, and registering a user's input information along with the still picture.

9. A method for displaying an image in a mobile communication terminal, the mobile communication terminal including a user data generator for generating user data according to a display mode, and a display unit for displaying image data on a first display area and displaying the user data on a second display area, the method comprising the steps of:
transmitting received image data and the user data generated by the user data generator to the first and second display areas of the display unit in a communication mode, and displaying a moving picture; and
when a still-picture capture command is generated at a time of displaying the received image data, compressing and encoding the image data displayed on the first display area of the display unit, generating image data of at least one still picture and image data of at least one thumbnail picture of a set size, and storing the generated image data.

10. The method as set forth in claim 9, further comprising the step of:
when the still-picture capture command is generated, displaying the user data for registering a still-picture name, a name of a place in which the still picture is captured, etc. On the second display area, and registering a user's input information along with the still picture.

11. A method for displaying an image in a mobile communication terminal, the mobile communication terminal including an image memory for storing image data of still pictures and image data of thumbnail pictures corresponding to the still pictures, a user data generator for generating user data according to a display mode, and a display unit for displaying the image data on a first display area and displaying the user data on a second display area, the method comprising the steps of:
displaying a predetermined number of thumbnail pictures stored in the image memory on the first display area in a thumbnail display mode;
when a first shift key is input in the thumbnail display mode, shifting a selection bar to a selected thumbnail picture;
when a second shift key is input in the thumbnail display mode, displaying the predetermined number of next thumbnail pictures stored in the image memory on the first display area; and
when a selection key is input in the thumbnail display mode, reading image data of a still picture corresponding to a selected thumbnail picture and displaying the image data of the still picture corresponding to the selected thumbnail picture on the first display area.

12. The method as set forth in claim 11, wherein the step of displaying the image data of the still picture corresponding to the selected thumbnail picture further comprises the step of:
displaying at least one of the user data including a still-picture name, a name of a place in which the still picture is captured on the second display area.

13. A method for displaying an image in a mobile communication terminal, the mobile communication terminal including a camera for capturing an object's image and generating image data, a user data generator for generating user data according to a display mode, and a display unit for displaying the image data on a first display area and displaying the user data on a second display area, the method comprising the steps of:
transmitting the image data generated by the camera and the user data generated by the user data generator to the first and second display areas of the display unit in an image capture mode, and displaying a moving picture;
when a still-picture capture command is generated in the image capture mode, compressing and encoding the image data displayed on the first display area of the display unit, generating image data of at least one still picture and image data of at least one thumbnail picture of a set size, and storing the generated image data; and
displaying the predetermined number of thumbnail pictures stored in the image memory on the first display area in a thumbnail display mode, reading image data of a still picture corresponding to a selected thumbnail picture when a selection key is input in the thumbnail display mode, and displaying the image data of the still picture corresponding to the selected thumbnail picture on the first display area.

14. The method as set forth in claim 13, further comprising the step of:
when the still-picture capture command is generated, displaying the user data for registering a still-picture name, a name of a place in which the still picture is captured, etc. on the second display area, and registering a user's input information along with the still picture.

15. The method as set forth in claim 13, wherein the step of displaying the image data of the still picture corresponding to the selected thumbnail picture further comprises the step of:
displaying at least one of the user data including a still-picture name, a name of a place in which the still picture is captured on the second display area.
